(19) United States
(12) Patent Application Publication
(10) Pub. No.: US 2007/0285458 A1
(43) Pub. Date: Dec. 13, 2007

(54) PRODUCTION PROCESS OF PIGMENT PARTICLES, LIQUID COMPOSITION CONTAINING THE PIGMENT PARTICLES, IMAGE FORMING PROCESS AND IMAGE FORMING APPARATUS

(75) Inventors: Kazumichi NAKAHAMA, Tokyo (JP); Takayuki Teshima, Yokohama-shi (JP); Yukio Hanyu, Isehara-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/746,992

(22) Filed: May 10, 2007

(30) Foreign Application Priority Data
Jun. 9, 2006 (JP) 2006-161523

(51) Int. Cl. C08J 3/00; B41J 2/01

(52) U.S. Cl. 347/20; 528/488

(57) ABSTRACT

A process for producing pigment particles with a polymer chain formed on the surfaces of the particles by grafting, the process including (1) causing a dispersant composed of a polymer compound having a polymerization initiation group to be contained in either one solvent of a first solvent and a second solvent, (2) obtaining a solution dissolving a pigment in the first solvent, (3) mixing the solution with the second solvent to precipitate pigment particles having the polymerization initiation group on the surfaces thereof, and (4) forming a polymer chain through grafting from the polymerization initiation group on the surfaces of the pigment particles.

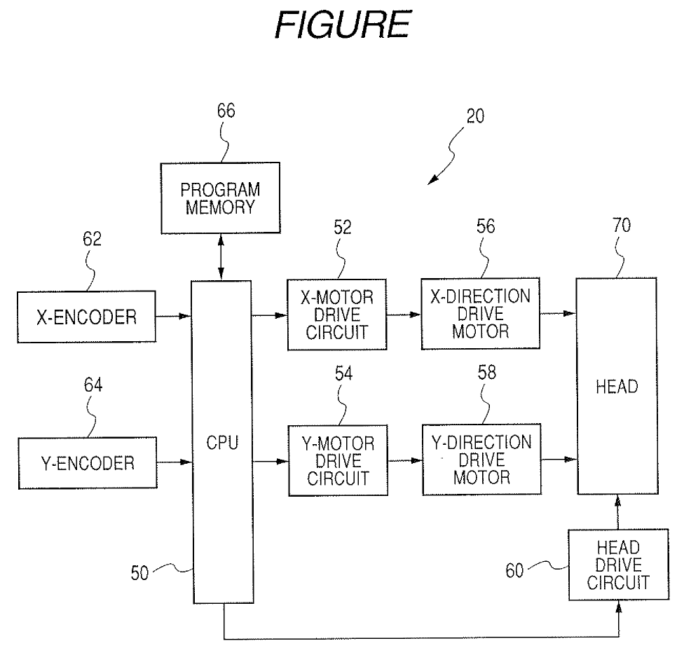

### BACKGROUND OF THE INVENTION

1. Field of the Invention

The present invention relates to a production process of pigment particles useful as an ink-jet ink, a liquid composition containing the pigment particles in a dispersed state, and an image forming process and an image forming apparatus using the liquid composition.

2. Description of the Related Art

In recent years, digital printing technology is making very dramatic progress. Typical examples of this digital printing technology include what is called electrophotographic technique or ink-jet technique, and its significance has been more and more increased as image forming technique in offices, homes and so forth.

In particular, the ink jet technique has such a great characteristic feature as compactness and low power consumption, as a direct recording method. Also, image quality is being rapidly improved as nozzles are made finer. An example of the ink jet technique is a method in which an ink fed from an ink tank is heated with heaters in nozzles to cause evaporation to bubbling, whereupon the ink is ejected to form images on a recording medium. Another example is a method in which the ink is ejected from nozzles by vibrating piezoelectric elements.

Water-soluble dye inks have been applied to these methods to date. However, the dye inks have involved problems of blurring or bleeding, feathering and weatherability.

In order to solve these problems, it has been investigated in recent years to use pigment inks (see U.S. Pat. No. 5,085,698). In fact, ink-jet inks containing a pigment dispersion in their ink compositions also begin to spread.

However, the pigment inks are often poor in long-term storage stability and ejection stability from an ink jet head compared with dye inks. In addition, images formed with the pigment inks generally tend to be low in color developability compared with images formed with the dye inks because they cause light scattering and/or light reflection by the influence of pigment particles.

As a method for improving the color developability of the pigment inks, it has been attempted to pulverize pigment particles. A pigment (hereinafter referred to as “fine pigment particles” pulverized to 100 nm or less suffers little influence of light scattering and increases its specific surface area and is thus expected to achieve the color developability comparable with that of a dye.

The pulverization of the pigment particles is generally mechanically conducted by means of a dispersing machine such as a sand mill, roll mill or ball mill. In these methods, the pulverization of the pigment is limited to the vicinity of primary particles (about 100 nm), and so it takes a lot of time and cost to require further pulverization. In addition, it is difficult to stably provide those having uniform quality (Japanese Patent Application Laid-Open No. 10-110111).

On the other hand, Japanese Patent Publication No. H06-096679 and Japanese Patent Application Laid-Open No. 2004-91560 have proposed a method for adjusting fine pigment particles by dissolving a pigment in a solvent and then mixing the solution of the pigment with a poor solvent for the pigment in the presence of a dispersant to reprecipitate the pigment (hereinafter referred to as “reprecipitation method”).

The pigment particles obtained by the reprecipitation method have such a feature that the surface properties thereof are greatly affected by the kind of the dispersant used and the form of adsorption.

Dispersants capable of being used in the reprecipitation method are restricted to those soluble in at least one of a solvent which dissolves the pigment and a poor solvent for the pigment.

In addition, since fine pigment particles are instantaneously formed according to the reprecipitation method, the adsorption form of a dispersant adsorbed on the surface of the pigment becomes a thermodynamically non-equilibrium state, for example, when the molecular weight of the dispersant used is high.

Such process restriction as described above is an extremely disadvantageous restriction, for example, when the fine pigment particles are applied to an ink-jet ink composition, particularly to an ink-jet ink composition for a thermal ink jet system.

In the ink-jet ink composition, the surface properties of the fine pigment particles (for example, degree of hydrophilicity and charging properties) are desirably complicatedly designed in order to ensure ejection stability in an ink jet nozzle and fixability to recording paper.

However, it has been a problem extremely difficult to be solved to control the surface properties of fine pigment particles obtained by the reprecipitation method because the dispersants usable in the reprecipitation method involve such restriction as described above.

### SUMMARY OF THE INVENTION

A process for producing pigment particles, which is provided by the present invention, is a process for producing pigment particles with a polymer chain formed on the surfaces of the particles through grafting, the process comprising (1) causing a dispersant composed of a polymer compound having a polymerization initiation group to be contained in either one solvent of a first solvent and a second solvent, (2) obtaining a solution dissolving a pigment in the first solvent, (3) mixing the solution with the second solvent to precipitate pigment particles having the polymerization initiation group on the surfaces thereof, and (4) forming a polymer chain through grafting from the polymerization initiation group on the surfaces of the pigment particles.

The present invention embraces a liquid composition containing the pigment particles produced by the process according to the present invention.

The present invention also embraces an ink jet recording ink composition comprising the liquid composition according to the present invention.

The present invention further embraces an image forming process comprising applying the ink composition according to the present invention to a medium, thereby recording an image.

The present invention still further embraces an image forming apparatus comprising a unit for applying the ink composition according to the present invention to a medium, thereby recording an image.

Further features of the present invention will become apparent from the following description of exemplary embodiments with reference to the attached drawing.

### BRIEF DESCRIPTION OF THE DRAWING

FIGURE is a block diagram illustrating the construction of an ink jet recording apparatus.

### DESCRIPTION OF THE EMBODIMENTS

The present invention provides a production process of fine pigment particles of the nanometer order, which have surface properties excellent in ejection stability and high size uniformity.

The present inventors have carried out an extensive investigation with a view toward solving the above-described problems. As a result, it has been found that desired surface properties can be effectively imparted to fine pigment particles by mixing a solution of a pigment with a poor solvent for the pigment in the presence of a dispersant having a polymerization initiation group to provide fine pigment particles having the polymerization initiation group on the surfaces thereof and forming a polymer chain from the polymer initiation group of the fine pigment particles through graft polymerization, thus leading to completion of the present invention.

The present invention can provide a production process of fine pigment particles of nanometer order, which have surface properties excellent in ejection stability and high size uniformity.

The present invention will hereinafter be described in detail.

The present invention is directed to a process for producing pigment particles with a polymer chain formed on the surfaces of the particles through grafting, the process including (1) causing a dispersant composed of a polymer compound having a polymerization initiation group to be contained in either one solvent of a first solvent and a second solvent, (2) obtaining a solution dissolving a pigment in the first solvent, (3) mixing the solution with the second solvent to precipitate pigment particles having the polymerization initiation group on the surfaces thereof, and (4) forming a polymer chain through grafting from the polymerization initiation group on the surfaces of the pigment particles.

According to the process of the present invention, fine pigment particles of the nanometer order, which have surface properties excellent in ejection stability and high size uniformity, can be obtained in a dispersed state.

Incidentally, the high size uniformity means that the particle size distribution of the pigment particles is narrow. The nanometer order means that the particle size of the pigment particles is 100 nm or less.

In the present invention, the mechanism with which the fine pigment particles are obtained in the dispersed state is as follows.

When the first solvent is mixed with the second solvent, the pigment in the dissolved state in the first solvent is rapidly insolubilized to form particle nuclei. In the process of aggregating the nuclei, the dispersant having the polymer initiation group is adsorbed on the surface of the pigment, whereby the fine pigment particles can be obtained in the dispersed state.

The fine pigment particles obtained in such a manner are coated with the dispersant, and so the pigment particles have such a feature that the polymerization initiation group derived from the dispersant is bonded to the surfaces thereof.

A process for imparting desired surface properties to the fine pigment particles will hereinafter be described.

A liquid mixture containing the fine pigment particles obtained by the above-described mechanism and a monomer for forming the polymer chain is prepared. An external stimulus such as temperature, photo-stimulus or addition of a catalyst is applied to the liquid mixture, thereby producing active species from the polymerization initiation group bonded to the surfaces of the fine pigment particles to graft a polymer chain with the active species as a starting point.

Since the properties of the polymer chain can be freely designed according to the kind of the monomer, the desired surface properties can be imparted to the fine pigment particles obtained by the present invention.

[Dispersant]

The dispersant used in the present invention is a polymer compound that can impart dispersion stability to the fine pigment particles in water or an aqueous solution and contains, in a part or the whole thereof, a monomer unit (hereinafter referred to as “polymerization initiation segment”) having a polymerization initiation group.

In the present specification, the polymerization initiation group means a functional group capable of producing active species participating in a polymerization reaction by virtue of temperature, light or addition of a catalyst.

As the polymerization reaction in the present invention, may be applied conventionally known polymerization reactions such as radical polymerization, cationic polymerization and anionic polymerization. However, the radical polymerization may be advantageously used from the viewpoints of polymerization capacity in the water system and richness of polymerizable monomers.

A polymerization initiation group capable of initiating radical polymerization, a polymerization initiation group capable of initiating cationic polymerization and a polymerization initiation group capable of initiating anionic polymerization will hereinafter be referred to as a radical polymerization initiation group, a cationic polymerization initiation group and an anionic polymerization initiation group, respectively.

The radical polymerization initiation group may be, for example, a substituent containing a structure having self-decomposability, such as an azo compound or peroxide, or may be a substituent containing a structure which produces active species by adding a catalyst, such as a combination of a diol-containing substituent and Ce⁴⁺. However, the polymerization initiation group contained in the polymer compound in the present invention is not limited thereto.

The present invention can be particularly favorably performed when the polymerization initiation group contained in the polymer compound is a living polymerization initiation group. Fine pigment particles obtained by using, as the dispersant, a polymer compound containing a living polymerization initiation group can graft a polymer chain from the surfaces thereof by living polymerization. Since the polymer chain formed by the living polymerization has a narrow molecular weight distribution of the polymer chain compared with a polymer chain formed by an ordinary polymerization, the polymer chain can be uniformly grafted on the surfaces of the fine pigment particles.

With the living polymerization, the active species participating in polymerization reaction is evenly produced from the polymerization initiation group, and so the polymer chain can be grafted with a high density on the surfaces of the fine pigment particles.

As the living polymerization in the present invention, may be applied conventionally known living polymerization processes such as living radical polymerization, living cationic polymerization and living anionic polymerization. However, the living radical polymerization is favorable from the viewpoint of easy handling.

A polymerization initiation group capable of initiating living radical polymerization, a polymerization initiation group capable of initiating living cationic polymerization and a polymerization initiation group capable of initiating living anionic polymerization will hereinafter be referred to as a living radical polymerization initiation group, a living cationic polymerization initiation group and a living anionic polymerization initiation group, respectively.

Examples of the living radical polymerization initiation group include substituents containing structures of a dithiocarbamate compound capable of initiating photo-iniferter polymerization that is a living radical polymerization, a nitrogen oxide capable of initiating nitroxide-mediated polymerization, a dithioester capable of initiating RAFT polymerization or a halide capable of initiating atom transfer radical polymerization.

These substituents may be those singly initiating the living polymerization or those initiating the living polymerization in combination with an additive for producing an active species.

For example, a halide-containing substituent capable of initiating atom transfer radical polymerization is a good example of those initiating the living polymerization in combination with an additive for producing an active species capable of initiating the living polymerization by forming a complex with a transition metal.

A general polymerization initiation group that is not a living polymerization initiation group may also be added upon the grafting of the polymer chain from the living polymerization initiation group, as needed.

The living polymerization initiation groups contained in the polymer compound according to the present invention have been described above. However, the living polymerization initiation groups in the present invention are not limited thereto, and other living polymerization initiation groups than those exemplified may also be applied within such limits that the same effect can be expected.

In the present invention, a polymer compound containing a repeating structure of a monomer unit having hydrophilicity (hereinafter referred to as “hydrophilic segment”) is used as a dispersant for the purpose of imparting dispersion stability to the fine pigment particles in water or an aqueous solution.

Examples of the hydrophilic segment include structures having a repeating unit structure such as a carboxylic acid, carboxylic acid salt, a structure containing a hydrophilic oxyethylene unit in plenty or a structure having a hydroxyl group. Specific examples thereof include structures having a repeating unit structure represented by a hydrophilic monomer, such as acrylic acid, methacrylic acid, a carboxylic acid salt such as an inorganic salt or organic salt of acrylic acid or methacrylic acid, a polyethylene glycol macromonomer, vinyl alcohol, or 2-hydroxyethyl methacrylate.

However, the hydrophilic segments contained in the polymer compounds of the dispersants in the present invention are not limited thereto, and any substance may be used within such limits that the objects of the present invention can be achieved.

In the present invention, as the hydrophilic segment contained in the polymer compound, either a repeating unit structure represented by one hydrophilic monomer or a copolymer structure having a repeating structure including a plurality of hydrophilic monomers may be applied. In addition, as the copolymer structure, either a random copolymer structure or a block copolymer structure may be suitably used within such limits that the objects of the present invention can be achieved.

In the present invention, a polymer compound containing a repeating structure of a monomer unit having hydrophilicity (hereinafter referred to as “hydrophobic segment”) is used as a dispersant for the purpose of imparting affinity to pigments.

Specific examples of the hydrophobic segment include structures containing a repeating unit structure having a hydrophobic unit such as an isobutyl, tert-butyl, phenyl, biphenyl or naphthyl group.

More specific examples thereof include structures having a hydrophobic monomer such as styrene or tert-butyl methacrylate as a repeating unit.

However, the hydrophobic segments contained in the polymer compounds in the present invention are not limited thereto, and any substance may be used within such limits that the objects of the present invention can be achieved.

In the present invention, as the hydrophobic segment contained in the polymer compound, either a repeating unit structure represented by one hydrophobic monomer or a copolymer structure having a repeating structure including a plurality of hydrophobic monomers may be applied. In addition, as the copolymer structure, either a random copolymer structure or a block copolymer structure may be suitably used within such limits that the objects of the present invention can be achieved.

As described above, a polymer compound containing the polymerization initiation segment, hydrophilic segment and hydrophobic segment as described above is essential to the dispersant according to the present invention. The polymerization initiation segment, hydrophilic segment and hydrophobic segment may be contained in either a random copolymer structure or a block copolymer structure in the polymer compound within such limits that the objects of the present invention can be achieved.

The present invention may be performed within such limits that the objects of the present invention can be achieved even when the polymerization initiation segment is the same substance as the hydrophilic segment or is the same substance as the hydrophobic segment.

The weight average molecular weight of the dispersant in the present invention is 500 or more to 1,000,000 or less, desirably 1,000 or more to 1,000,000 or less.

If the weight average molecular weight exceeds 1,000,000, entanglement within such a polymer compound and between polymer compounds becomes too much. If the weight average molecular weight is lower than 500 on the other hand, the molecular weight may be too low for the polymer compound to exhibit a function as the dispersant, so that such a polymer compound cannot impart good dispersion stability to the fine pigment particles.

The weight average molecular weight can be measured by a light scattering method, X-ray small angle scattering method, sedimentation equilibrium method, diffusion method or ultracentrifugal method or any of various kinds of chromatography. The weight average molecular weight in the present invention is a weight average molecular weight in terms of polystyrene as measured by GPC (gel permeation chromatography)

The dispersants in the present invention may be used either singly or in any combination thereof.

No particular limitation is imposed on the proportion of the dispersant used. However, the proportion is 0.05 part by mass or more per 1 part by mass of the pigment. If the proportion is lower than 0.05 part by mass per 1 part by mass of the pigment, a sufficient dispersing effect may not be achieved in some cases.

The proportion of the dispersant used is also 50 parts by mass or less per 100 parts by mass of an aprotic solvent. If the amount of the dispersant is more than 50 parts by mass per 100 parts by mass of the aprotic solvent, it may be difficult in some cases to completely dissolve the dispersant.

The dispersant having the polymerization initiation group may also be used in combination with a general dispersant having no polymerization initiation group within such limits that the objects of the present invention can be achieved.

It is necessary that the dispersant according to the present invention is soluble in at least one solvent of the first solvent and the second solvent. If the dispersant is insoluble in both first solvent and second solvent, the dispersant cannot be caused to efficiently diffuse into and adsorb on the pigment particles, so that the pigment particles can be obtained only as coarse pigment particles.

More specifically, when the dispersant is contained in the first solvent in the present invention, the dispersant is required to be soluble in at least the first solvent. In this case, the dispersant may be soluble or insoluble in the second solvent. When the dispersant is insoluble in the second solvent, the precipitation rate of the dispersant on pigment particles formed by mixing of the first solvent and the second solvent becomes high, which is advantageous to the formation of fine pigment particles, which have high size uniformity and are of the order of nanometer.

When the dispersant is contained in the second solvent, the dispersant needs to be soluble in at least the second solvent. In this case, the dispersant may be soluble or insoluble in the first solvent, and any compound may be applied within such limits that the objects of the present invention can be achieved.

When it is difficult due to limitation of the process to use the dispersant having the polymerization initiation group or it is more advantageous to the formation of the fine pigment particles to use a dispersant having no polymerization initiation group, the polymer chain can also be grafted on the surfaces of the fine pigment particles according to a process described below.

This process includes forming fine pigment particles and then introducing a polymerization initiation segment onto the surfaces of fine pigment particles.

The dispersant used in the formation of the fine pigment particles desirably has, in addition to the hydrophilic segment and hydrophobic segment, a functional group reacting with a compound having a polymerization initiation group, for example, a hydroxyl group, carboxyl group, amino group or chloromethyl group. When the dispersant does not have such a functional group, the functional group is desirably introduced by a suitable treatment. The polymerization initiation segment introduced onto the surfaces of the fine pigment particles and the polymer chain grafted with the polymerization initiation segment as a starting point may have any of the above-described features.

[Polymer Chain]

The polymer chain grafted in the present invention is a polymer chain having a dispersing function in water or an aqueous solution and particularly in an ink composition which will be described subsequently.

Examples of the hydrophilic segment include structures having a repeating unit structure of a hydrophilic unit, such as a carboxylic acid, carboxylic acid salt, a structure containing a hydrophilic oxyethylene unit in plenty or a structure having a hydroxyl group. Specific examples thereof include structures having a repeating unit structure represented by a hydrophilic monomer, such as acrylic acid, methacrylic acid, a carboxylic acid salt such as an inorganic salt or organic salt of acrylic acid or methacrylic acid, a polyethylene glycol macromonomer, vinyl alcohol, or 2-hydroxyethyl methacrylate.

However, the hydrophilic segment contained in the polymer chain in the present invention is not limited thereto, and any substance may be used within such limits that the objects of the present invention can be achieved.

In the present invention, as the hydrophilic segment contained in the polymer chain, either a repeating unit structure represented by one hydrophilic monomer or a copolymer structure having a repeating structure including a plurality of hydrophilic monomers may be applied. In addition, as the copolymer structure, either a random copolymer structure or a block copolymer structure may be suitably used within such limits that the objects of the present invention can be achieved.

The polymer chain of the present invention may be a polymer chain containing a hydrophobic segment in addition to the hydrophilic segment within limits having a dispersing function in the ink composition which will be described subsequently.

The hydrophilic segment and hydrophobic segment may be contained in either a random copolymer structure or a block copolymer structure in the polymer chain within such limits that the objects of the present invention can be achieved.

Specific examples of the hydrophobic segment include structures containing a repeating unit structure having a hydrophobic unit such as an isobutyl, tert-butyl, phenyl, biphenyl or naphthyl group.

More specific examples thereof include structures having a hydrophobic monomer such as styrene or tert-butyl methacrylate as a repeating unit.

However, the hydrophobic segment contained in the polymer chain in the present invention is not limited thereto, and any substance may be used within such limits that the objects of the present invention can be achieved.

In the present invention, as the hydrophobic segment contained in the polymer chain, either a repeating unit structure represented by one hydrophobic monomer or a copolymer structure having a repeating structure including a plurality of hydrophobic monomers may be applied. In addition, as the copolymer structure, either a random copolymer structure or a block copolymer structure may be suitably used within such limits that the objects of the present invention can be achieved.

The weight average molecular weight of the polymer chain in the present invention is 500 or more to 1,000,000 or less, desirably 1,000 or more to 1,000,000 or less.

If the weight average molecular weight exceeds 1,000,000, entanglement within such a polymer chain and between polymer chains becomes too much. If the weight average molecular weight is lower than 500 on the other hand, the molecular weight may be too low for the polymer chain to exhibit a dispersing function, so that such a polymer chain cannot impart good dispersion stability to the fine pigment particles.

The weight average molecular weight can be measured by a light scattering method, X-ray small angle scattering method, sedimentation equilibrium method, diffusion method or ultracentrifugal method or any of various kinds of chromatography. The weight average molecular weight in the present invention is a weight average molecular weight in terms of polystyrene as measured by GPC (gel permeation chromatography)

[Pigment]

The pigment used in the present invention may be any pigment so far as it is soluble in the first solvent and can achieve the objects of the present invention. The pigment is desirably a stable organic pigment exhibiting no reactivity under dissolved conditions.

More specifically, pigments used in printing inks and paints may be used. Examples thereof include azo, disazo, condensed azo, anthraquinone, dianthraquinonyl, anthrapyridine, anthanthrone, thioindigo, naphthol, benzoimidazolone, pyranthrone, phthalocyanine, flavanthrone, quinacridone, dioxazine, diketopyrrolopyrrole, indanthrone, isoindolinone, isoindoline, quinophthalone, perinone and perylene pigments, vat dye pigments, metal complex pigments, basic dye pigments, fluorescent pigments, and daylight fluorescent pigments.

Specific examples thereof include C.I. Pigment Yellow 1, 3, 12, 13, 14, 17, 42, 55, 62, 73, 74, 81, 83, 93, 95, 97, 108, 109, 110, 128, 130, 151, 155, 158, 139, 147, 154, 168, 173, 180, 184, 191 and 199; C.I. Pigment Red 2, 4, 5, 22, 23, 31, 48, 53, 57, 88, 112, 122, 144, 146, 150, 166, 171, 175, 176, 177, 181, 183, 184, 185, 202, 206, 207, 208, 209, 213, 214, 220, 254, 255, 264 and 272; C.I. Pigment Blue 16, 25, 26, 56, 57, 60, 61 and 66; C.I. Pigment Violet 19, 23, 29, 37, 38, 42, 43 and 44; C.I. Pigment Orange 16, 34, 35, 36, 61, 64, 66, 71 and 73; and C.I. Pigment Brown 23 and 38. These organic pigments may be used either singly or in any combination thereof. Organic pigment derivatives with a substituent introduced into the basic skeletons of the respective organic pigments may also be used within such limits that the objects of the present invention can be achieved.

[First Solvent]

The first solvent used in the present invention is desirably an aprotic solvent. In particular, a solvent having a solubility of 5% or more with respect to the second solvent is desirably used, and a solvent freely mixed with the second solvent is more desirably used.

If the pigment is dissolved in a solvent having a solubility lower than 5% with respect to the second solvent, it is disadvantageous in that the pigment-containing particles are hard to precipitate when the solution is mixed with water, and coarse particles are easily formed. In addition, it is also disadvantageous in that there is a tendency of adversely affecting the dispersion stability of the resulting fine pigment particles.

Specific desirable examples of the first solvent include dimethyl sulfoxide, dimethyl-imidazolidinone, sulfolane, N-methylpyrrolidone, dimethylformamide, acetonitrile, acetone, dioxane, tetramethylurea, hexamethylphosphorylamide, hexamethyl-phosphoryltriamide, pyridine, propionitrile, butanone, cyclohexanone, tetrahydrofuran, tetrahydropyrane, ethylene glycol diacetate and y-butyrolactone. Among these, dimethyl sulfoxide, N-methylpyrrolidone, dimethylformamide, dimethylimidazolidinone, sulfolane, acetone, acetonitrile and tetrahydrofuran are desirable. These solvents may be used either singly or in any combination thereof.

No particular limitation is imposed on the use proportion of the aprotic solvent. However, the solvent is used in a range of desirably from 2 parts by mass or more to 500 parts by mass or less, more desirably from 5 parts by mass or more to 100 parts by mass or less, per 1 part by mass of the organic pigment from the viewpoints of good dissolved state of the organic pigment, easiness of formation of fine particles having a desired particle size and good color density of the resulting aqueous dispersion. When it is difficult to dissolve the organic pigment with only the aprotic solvent, an alkali, which will be described subsequently, may be used to enhance the solubility of the organic pigment.

[Alkali]

As the alkali used in the present invention, any alkali may be used so far as it can solubilize the organic pigment in the aprotic solvent and achieve the objects of the present invention. However, hydroxides of alkali metals, alkoxides of alkali metals, hydroxides of alkaline earth metals, alkoxides of alkaline earth metals and organic strong bases are desirable from the viewpoint of the high organic-pigment-solubilizing ability thereof.

Specifically, lithium hydroxide, sodium hydroxide, potassium hydroxide, calcium hydroxide, potassium tert-butoxide, potassium methoxide, potassium ethoxide, sodium methoxide, sodium ethoxide, quaternary ammonium compounds such as tetramethylammonium hydroxide and tetrabutylammonium hydroxide, 1,8-diazabicyclo[5,4,0]-7-undecene, 1,8-diazabicyclo-[4,3,0]-7-nonene, and guanidine may be used.

These alkalis may be used either singly or in any combination thereof. No particular limitation is imposed on the proportion of the base used. However, it is desirably used in a range of from 0.01 to 1,000 parts by mass per 1 part by mass of the organic pigment. If the proportion of the alkali is lower than 0.01 part by mass per 1 part by mass of the organic pigment, disadvantage may be involved in some cases in that there is a tendency to become hard to completely dissolve the organic pigment together with the polymer compound in the aprotic solvent. If the proportion is higher than 1,000 parts by mass, disadvantage may be involved in some cases in that the alkali becomes hard to be dissolved in the aprotic solvent, and in that increase in the solubility of the organic pigment also becomes unexpectable.

[Additive]

In order to completely dissolve the alkali in the aprotic solvent, some quantity of a solvent having high solubility for the alkali, such as water or a lower alcohol may be added to the aprotic solvent. These solvents act as an alkali-solubilizing aid to increase the solubility of the alkali in the aprotic solvent, and so the dissolution of the organic pigment becomes easy.

Since disadvantage is involved in that the solubility of the organic pigment is lowered when the rate of addition is 50% by mass or more based on the quantity of the whole solvent, a rate of addition of the order from 0.5 to 30% by mass is generally most effective, because the solubility of the alkali with respect to only the aprotic solvent is relatively low. Specifically, water, methanol, ethanol, n-propanol, isopropanol or butyl alcohol may be used.

In order to quickly dissolve the organic pigment by reducing the amount of the alkali used to the minimum upon dissolving the organic pigment, it is desirable to add the alkali in the form of a solution in water or the lower alcohol to the aprotic solvent, in which the organic pigment has been suspended, until the pigment is dissolved. At this time, removal of foreign matter can be conducted with ease because the pigment is in the form of a solution. In the selection of these alkali-solubilizing aids, it is important to ensure compatibility with the dispersant.

When the organic pigment is dissolved in the aprotic solvent, at least one of a crystal-growth-preventing agent, an ultraviolet absorbent, an antioxidant and resin additives may be added in addition to the organic pigment and polymer compound as needed.

Examples of the crystal-growth-preventing agent include phthalocyanine derivatives and quinacridone derivatives well known in this technical field. Specific examples thereof include phthalimidomethyl derivatives of phthalocyanine, sulfonic acid derivatives of phthalocyanine, N-(dialkylamino)methyl derivatives of phthalocyanine, N-(dialkylaminoalkyl)sulfonamide derivatives of phthalocyanine, phthalimidomethyl derivatives of quinacridone, sulfonic acid derivatives of quinacridone, N-(dialkylamino)methyl derivatives of quinacridone and N-(dialkylaminoalkyl)sulfonamide derivatives of quinacridone.

Examples of the ultraviolet absorbent include ultraviolet absorbents such as metal oxides, aminobenzoate ultraviolet absorbents, salicylate ultraviolet absorbents, benzophenone ultraviolet absorbents, benzotriazole ultraviolet absorbents, cinnamate ultraviolet absorbents, nickel chelate ultraviolet absorbents, hindered amine ultraviolet absorbents, urocanic acid ultraviolet absorbents and vitamin ultraviolet absorbents.

Examples of the antioxidant include hindered phenolic compounds, thioalkanic acid ester compounds, organic phosphorus compounds and aromatic amines.

Examples of the resin additives include synthetic resins such as anionically modified polyvinyl alcohol, cationically modified polyvinyl alcohol, polyurethane, carboxymethyl cellulose, polyester, polyallylamine, polyvinyl pyrrolidone, polyethylene imine, polyamine sulfone, polyvinylamine, hydroxyethyl cellulose, hydroxypropyl cellulose, melamine resins and modified products thereof.

All of these crystal-growth-preventing agents, ultraviolet absorbents and resin additives may be used either singly or in any combination thereof.

[Second Solvent]

As the second solvent used in the present invention, any solvent may be used so far as it is compatible with the first solvent to be used and can achieve the objects of the present invention. In particular, water or an aqueous solution is desirable.

Additives may be contained in water or the aqueous solution to be used. As the additives, any additives may be used so far as they are compatible with water or the aqueous solution and can achieve the objects of the present invention. Examples thereof include publicly known pH adjustors including the above-described alkalis and pH buffers, and salts. In order to enhance the compatibility of the first solvent with water or the aqueous solution, an organic solvent, for example, an alcohol may also be contained. In this case, the organic solvent contained is not limited to the alcohol, and any organic solvent may be used so far as it can achieve the objects of the present invention.

[Mixing method] In order to obtain the fine pigment particles, which have high size uniformity and are of the order of nanometer, the mixing of the first solvent with the second solvent is desirably conducted as quickly as possible. Any of the conventionally known devices used in stirring, mixing, dispersion and crystallization, such as an ultrasonic oscillator, a full-zone agitating blade, an internal circulation type stirring device, an external circulation type stirring device, and a flow rate and ion concentration controlling device may be used in the mixing.

The mixing may also be conducted in continuously flowing water. As a method for pouring the pigment solution into water, may be used any of the conventionally known liquid-pouring methods. However, it is desirable that the solution be poured into or fed onto water as an injection flow from a nozzle of a syringe, needle or tube. Incidentally, the solution may also be poured from a plurality of nozzles for the purpose of completing the pouring in a short period of time. In order to enhance the mixing efficiency of the first solvent with the second solvent, the form and size of a mixing container may also be properly designed. For example, the mixing of the first solvent with the second solvent in a micro-space such as a micro-reactor is desirable because the mixing efficiency of the two solvents becomes high, and fine particles are easily formed.

No particular limitation is imposed on the temperatures of the first and second solvents when these solvents are mixed. However, the temperature of the solution upon the mixing is desirably controlled within the following range in view of the fact that the temperature of the solution greatly affects the size of the pigment precipitated.

The temperature of the solution is desirably controlled within the range of from −50° C to 500° C, more desirably from −30° C. to 100° C., still more desirably from −20° C. to 50° C., for the purpose of obtaining fine pigment particles having a particle size of the nanometer order. In order to surely achieve good flowability of the solution at this time, a publicly known freezing point depressant such as ethylene glycol, propylene glycol or glycerol may be added to water to be mixed.

[Concentrating Method]

The liquid composition containing the fine pigment particles obtained in the present invention may be used as it is, and may be used in various application fields by concentrating and purifying the composition as needed. In a concentrating and purifying method, may be used any of the conventionally known devices used in concentration and purification, such as centrifugal separators, evaporators and ultrafilters.

[Ink Composition]

When the liquid composition according to the present invention is used as an ink composition, various additives and aids may be added to the liquid composition as needed. A dispersion stabilizer for stably dispersing a pigment in a solvent is included as one of the additives. Although the fine pigment particles contained in the liquid composition according to the present invention are stably dispersed by the polymer compound making up the fine pigment particles, another dispersion stabilizer may also be added when dispersion is insufficient.

A resin having both hydrophilic segment and hydrophobic segment or a surfactant may be used as another dispersion stabilizer. Examples of the resin having both hydrophilic segment and hydrophobic segment include copolymers of a hydrophilic monomer and a hydrophobic monomer.

Examples of the hydrophilic monomer include acrylic acid, methacrylic acid, maleic acid, fumaric acid, monoesters of the carboxylic acids described above, vinylsulfonic acid, styrenesulfonic acid, vinyl alcohol, acrylamide and methacryloxyethyl phosphate.

Examples of the hydrophobic monomer include styrene, styrene derivatives such as α-methylstyrene, vinylcyclohexane, vinylnaphthalene derivatives, acrylic acid esters and methacrylic acid esters.

Any of copolymers of various forms such as random, block and graft copolymers may be used as the copolymer. As a matter of course, both hydrophilic monomer and hydrophobic monomer are not limited to those described above.

An anionic, nonionic, cationic or amphoteric surfactant may be used as the surfactant.

Examples of the anionic surfactant include fatty acid salts, alkyl sulfate salts, alkylarylsulfonic acid salts, alkyl diaryl ether disulfonic acid salts, dialkylsulfosuccinic acid salts, alkylphosphonic acid salts, naphthalenesulfonic acid-formalin condensates, polyoxyethylene alkylphosphate salts and glycerol borate fatty acid esters.

Examples of the nonionic surfactant include polyoxyethylene alkyl ethers, polyoxyethylene-oxypropylene block copolymers, sorbitan fatty acid esters, glycerol fatty acid esters, polyoxyethylene fatty acid esters, polyoxyethylenealkylamines, fluorine-containing surfactants and silicon-containing surfactants.

Examples of the cationic surfactant include alkylamine salts, quaternary ammonium salts, alkylpyridinium salts and alkylimidazolinium salts.

Examples of the amphoteric surfactant include alkylbetaines, alkylamine oxides and phosphatidyl choline. Incidentally, the surfactants are also not limited to those mentioned above.

Besides, an aqueous solvent may be added to the liquid composition according to the present invention as needed. When the liquid composition is used as an ink-jet ink in particular, the aqueous solvent is used for the purpose of preventing drying of the ink at orifices and solidification of the ink. Aqueous solvents may be used either singly or as a mixture thereof.

As the aqueous solvent, any of the solvents described above may be used. When the liquid composition is used as an ink, the content of the aqueous solvent is within a range of from 0.1 to 60% by mass, desirably from 1 to 40% by mass based on the whole mass of the ink.

When the liquid composition is used as an ink, examples of other additives include pH adjustors for achieving stabilization of the ink and obtaining stability of the ink to piping in a recording apparatus, penetrants for accelerating penetration of the ink into a recording medium to facilitate apparent drying, and mildewproofing agents for preventing occurrence of mildew in the ink.

Besides, chelating agents for blocking metal ions in the ink to prevent precipitation of metals at a nozzle portion and precipitation of insoluble matter in the ink, antifoaming agents for preventing occurrence of foams upon circulation, transfer or preparation of a recording liquid, antioxidants, viscosity modifiers, conductivity-imparting agents and ultraviolet absorbents may also be added.

The ink composition according to the present invention can be prepared by mixing the liquid composition according to the present invention with the above-described components, and uniformly dissolving or dispersing them. When an excess amount of the polymer compound and additives are contained in the ink composition prepared, they may be suitably removed by a publicly known method such as centrifugal separation or dialysis to re-adjust the ink composition.

[Image forming process, and liquid application method and apparatus] The composition according to the present invention can be used in various kinds of image forming methods such as various printing methods, ink-jet methods and electrophotographic methods as well as apparatuses therefor, and an image can be formed by an image forming method using such an apparatus. When the liquid composition is used, the liquid composition may be used in a liquid application method for forming a minute pattern by an ink-jet method or for administering a drug.

The image forming process according to the present invention is a process for forming an excellent image with the ink composition according to the present invention. The image forming process according to the present invention is desirably an image forming process including ejecting the ink composition according to the present invention from an ink-ejecting part to apply the composition to a recording medium, thereby conducting recording. A process using an ink-jet method in which thermal energy is applied to an ink to eject the ink is desirably used for forming an image.

In the ink composition according to the present invention, bleeding and/or feathering on a recording medium can be inhibited by using stimuli due to a polyvalent cation in combination.

The block polymer compound according to the present invention has such a feature that the polymer compound contains a repeating unit having an organic acid including a polycyclic aromatic ring. The organic acid including the polycyclic aromatic ring is easy to cause an interaction with a polyvalent cation due to its strong hydrophobicity to easily cause aggregation through the polyvalent cation. Therefore, when the polyvalent cation is present on a recording medium, the ink composition quickly causes aggregation, whereby an ink composition, a liquid application method and a liquid application apparatus, by which bleeding and/or feathering on a recording medium can be improved, may also be provided.

Desirable examples of the polyvalent cation include, as metal cations, divalent cations such as Ca, Cu, Mg, Ni, Zn, Fe and Co, and trivalent cations such as Al, Nd, Y, Fe and La. Examples of non-metal cations include a diammonium cation and a triammonium cation. However, the polyvalent cations are not limited thereto.

As a method for applying the polyvalent cation to a recording medium, a recording medium to which the polyvalent cation has been applied in advance may be used, or a method in which the polyvalent cation is shot throughout the whole region forming an image by an ink-jet head may also be used.

As a method for applying the stimuli, may be applied various methods. As a preferred embodiment, a method for applying stimuli in the case where the stimuli are of a polyvalent cation will be described. As described in, for example, Japanese Patent Application Laid-Open No. S64-063185, a polyvalent cation may be shot throughout the whole region forming an image by an ink-jet head. It is also desirable that the polyvalent cation has been applied to the recording medium in advance.

Regarding ink jet printers using the ink-jet ink composition according to the present invention, may be mentioned various ink jet recording apparatus such as a piezo ink jet system using a piezoelectric element and a Bubble-Jet (trademark) system in which thermal energy is applied to an ink to bubble the ink, thereby conducting recording.

This ink jet recording apparatus is schematically described below with reference to FIGURE. Incidentally, FIGURE shows an example of the construction, which by no means limits the present invention. FIGURE is a block diagram showing the construction of the ink-jet recording apparatus.

FIGURE shows a case in which a head is moved to perform recording on a recording medium. In FIGURE, an X-direction drive motor 56 and a Y-direction drive motor 58, which are to drive a head 70 in the X-Y directions, are connected to a CPU 50, which controls the whole motion of the recording apparatus, via an X-motor drive circuit 52 and a Y-motor drive circuit 54, respectively.

According to instructions from the CPU, the X-direction drive motor 56 and the Y-direction drive motor 58 are driven through the X-motor drive circuit 52 and the Y-motor drive circuit 54, respectively, and the head 70 is then positioned in respect to the recording medium.

As illustrated in FIGURE, to the head 70, a head drive circuit 60 is connected in addition to the X-direction drive motor 56 and the Y-direction drive motor 58. The CPU 50 controls the head drive circuit 60 to drive the head 70, i.e., to eject an ink-jet ink.

To the CPU 50, an X-encoder 62 and a Y-encoder 64, which are to detect the positions of the head, are further connected, and positional information as to the head 70 is input thereto. A control program is also input into a program memory 66.

The CPU 50 causes the head 70 to move based on this control program and the positional information sent from the X-encoder 62 and Y-encoder 64, and causes the head 70 disposed at the desired position on the recording medium to eject the ink-jet ink. In this way, a desired image can be formed on the recording medium.

Also, in the case of an image recording apparatus in which a plurality of ink-jet inks can be loaded, the operation as described above may be repeated given times in respect to the ink-jet inks, whereby the desired image can be formed on the recording medium.

After the ejection of the ink-jet ink, the head 70 may also be optionally moved to a position where a removing unit (not illustrated) for removing an excess ink adhered to the head 70 is disposed, to clean the head 70 by wiping or the like. As a specific method for such cleaning, a conventional method may be used as it is.

After the image has been formed, the recording medium on which the image has been formed is replaced by a new recording medium by way of a recording medium transporting mechanism not illustrated.

Incidentally, in the present invention, the above embodiment may be modified or transformed as long as such modification or the like does not deviate from the gist of the present invention.

For example, in the foregoing description, an example is shown in which the head 70 is moved in the directions of X-Y axes. This head 70 may instead be so made as to move only the X-axis direction (or the Y-axis direction) and the recording medium may be moved in the Y-axis direction (or the X-axis direction), to form an image while moving these interlockingly.

The present invention brings a superior effect on a head equipped with a unit for generating thermal energy (e.g., an electrothermal converter or a laser beam) as the energy utilized for ejecting the ink-jet ink, and ejecting the ink-jet ink by the action of the thermal energy. Such a system enables achievement of highly minute image formation. The use of the ink-jet ink compositions according to the present invention enables much superior image formation.

The typical construction and principles of the apparatus equipped with the above-described unit for generating thermal energy are desirably those using the fundamental principles disclosed in, for example, U.S. Pat. Nos. 4,723,129 and 4,740,796.

This system is applicable to any of what are called an On-Demand type and a continuous type. In particular, the On-Demand type is effective because a driving signal, which corresponds to ejection information and gives a rapid temperature rise exceeding nuclear boiling, is applied to an electrothermal converter, thereby causing film boiling on the heat-acting surface of a head, so that a bubble can be formed in the liquid in response to the driving signal in relation of one to one. The liquid is ejected through an ejection opening by the growth-contraction of this bubble to form at least one droplet.

When the driving signal is applied in the form of a pulse, the growth-contraction of the bubble is suitably conducted in a moment, so that the ejection of the liquid excellent in responsiveness in particular can be achieved. It is therefore desirable to use such pulsed signals.

As the pulsed driving signal, such signals as described in U.S. Pat. Nos. 4,463,359 and 4,345,262 are suitable. When the conditions described in U.S. Pat. No. 4,313,124 that discloses an invention relating to the rate of temperature rise on the heat-acting surface are adopted, far excellent ejection can be conducted.

As the construction of the head, may be adopted such combined constructions (linear liquid flow path or perpendicular liquid flow path) of ejection openings, a liquid flow path and electrothermal converters as disclosed in the specifications of the above-described U.S. Patents.

Besides, constructions based on U.S. Pat. Nos. 4,558,333 and 4,459,600 which disclose the construction in which a heat-acting portion is arranged in a curved region may also be included in the present invention.

In addition, constructions based on Japanese Patent Application Laid-Open Nos. 59-123670 and 59-138461 may also be effective for the present invention. In other words, ejection of ink-jet ink can be efficiently performed with certainty according to the present invention even when the type of the head is any type.

Further, in the image forming apparatus according to the present invention, the present invention can be effectively applied to a full-line type head having a length corresponding to the longest width of recording media. Such a head may be either of such a construction that the length is met by a combination of plural heads or of such a construction as to be one head integrally formed.

In addition, the present invention is effective even in a serial type such as a head fixed to an apparatus body and a replaceable chip type head, in which electrical connection to an apparatus body and the feed of an ink from the apparatus body become feasible by installing the head in the apparatus body.

Further, the apparatus according to the present invention may additionally have a droplet removing unit. When such a unit is added, a far excellent ejecting effect can be realized.

Besides, addition of preliminary auxiliary units which are provided as the constitution of the apparatus according to the present invention is desirable because the effects of the present invention can be more stabilized. As specific examples thereof, may be mentioned capping units for the head, pressurizing or sucking units and preliminary heating units for conducting heating by using electrothermal converters, other heating elements than these or combinations thereof.

In the present invention, the above-described film boiling system is most effective. The amount of an ink-jet ink ejected from each ejection orifice of the ejection head in the apparatus according to the present invention is desirably within a range of from 0.1 to 100 picoliters.

The ink compositions according to the present invention may also be used in indirect recording apparatus using a recording system in which an ink is applied to an intermediate transfer member, and the applied ink is then transferred to a recording medium such as paper. Further, the ink compositions may also be applied to apparatus making good use of an intermediate transfer member by a direct recording system.

### EXAMPLES

The present invention will hereinafter be described in detail by the following Examples. However, the present invention is not limited to these examples.

### Example 1

### <Synthesis of Dispersant>

A Schlenk's tube for reaction was charged with methacrylic acid (MAc), 4-vinylbenzyl chloride (VBC), styrene (St) and toluene to prepare a reaction solution.

After the interior of the Schlenk's tube was purged with nitrogen, solution polymerization was caused to progress by using AIBN as an initiator, thereby synthesizing poly(MAc-r-VBC-r-St). ‘r’ indicates random copolymerization.

The molecular weight of the poly(MAc-r-VBC-r-St) was evaluated by GPC. As a result, Mn was 2,400, and Mw/Mn was 2.72.

NMR measurement revealed that the copolymerization compositional ratio among the MAc unit, VBC unit and St unit was about 2:1:2.

A chloromethyl group derived from the poly(MAc-r-VBC-r-St) was then reacted with sodium N,N-diethyldithiocarbamate in water, thereby synthesizing a polymer compound having a photo-iniferter group.

The amount of sodium N,N-diethyldithiocarbamate introduced into the poly(MAc-r-VBC-r-St) was identified by NMR. As a result, it was found that the amount was 73% based on the VBC unit. The polymer compound with sodium N,N-diethyldithiocarbamate introduced into the VBC of the poly(MAc-r-VBC-r-St) will hereinafter be referred to as Polymer 1.

<Preparation of Liquid Composition Containing Fine Pigment Particles>

Fifteen parts by mass of the polymer compound (Polymer 1) synthesized was dissolved in 100 parts by mass of tetrahydrofuran, and 5 parts by mass of copper tetra-tert-butylphthalocyanine was dissolved in the resultant solution while stirring for 2 hours in a container.

This pigment solution was quickly poured by means of a syringe into distilled water under stirring by means of a stirrer while conducting an ultrasonic treatment, thereby precipitating copper tetra-tert-butylphthalocyanine.

All the experimental operations described above were performed at 25° C. The average particle size of the fine pigment particles including copper tetra-tert-butylphthalocyanine was measured at 25° C. in distilled water by means of DLS-7000 (manufactured by Otsuka Electronics Co., Ltd.). As a result, the average particle size was found to be 29.7 nm.

<Grafting of Polymer Chain>

A Schlenk's tube for reaction was charged with the fine pigment particles, acrylic acid (AAc), 2-hydroxyethyl methacrylate (HEMA) and distilled water to prepare a reaction solution.

After the interior of the Schlenk's tube was purged with nitrogen, photo-iniferter polymerization was caused to progress at room temperature, thereby grafting poly(HEMA-r-AAc) on the surfaces of the fine pigment particles. In this reaction, a lamp having an irradiation wavelength of from 312 nm to 577 nm was used as a UV lamp.

The average particle size of the resultant pigment dispersion was measured at 25° C. in distilled water by means of DLS-7000 (manufactured by Otsuka Electronics Co., Ltd.). As a result, the average particle size was found to be 40.2 nm, and so it was confirmed that the polymer chain was grafted on the surfaces of the fine pigment particles.

### Example 2

<Preparation of Liquid Composition Containing Fine Pigment Particles>

Twenty parts by mass of the polymer compound (Polymer 1) synthesized was dissolved in 100 parts by mass of tetrahydrofuran, and 5 parts by mass of C.I. Pigment Red 122 magenta pigment was suspended in the resultant solution while stirring for 2 hours in a container.

An aqueous solution of potassium hydroxide was then added dropwise little by little to dissolve the magenta pigment. This pigment solution was quickly poured by means of a syringe into distilled water under stirring by means of a stirrer while conducting an ultrasonic treatment, thereby precipitating the magenta pigment.

The average particle size of the fine pigment particles including C.I. Pigment Red 122 was measured at 25° C. in distilled water by means of DLS-7000 (manufactured by Otsuka Electronics Co., Ltd.). As a result, the average particle size was found to be 27.2 nm.

<Grafting of Polymer Chain>

A Schlenk's tube for reaction was charged with the fine pigment particles, acrylic acid (AAc), 2-hydroxyethyl methacrylate (HEMA) and distilled water to prepare a reaction solution.

After the interior of the Schlenk's tube was purged with nitrogen, photo-iniferter polymerization was caused to progress at room temperature, thereby grafting poly(HEMA-r-AAc) on the surfaces of the fine pigment particles. In this reaction, a lamp having an irradiation wavelength of from 312 nm to 577 nm was used as a UV lamp.

The average particle size of the resultant pigment dispersion was measured at 25° C. in distilled water by means of DLS-7000 (manufactured by Otsuka Electronics Co., Ltd.). As a result, the average particle size was found to be 45.3 nm, and so it was confirmed that the polymer chain was grafted on the surfaces of the fine pigment particles.

<Preparation of Ink Composition>

Tetrahydrofuran was removed from a liquid composition containing the fine magenta pigment particles grafted with the polymer chain prepared in Example 2 by using a permeable membrane. The permeable membrane used herein is a molecular porous membrane tubing (MWCO:3500) (product of SPECTRUM Laboratories Co.). A concentrated liquid having a pigment content of 10% was obtained by additionally using an evaporator.

Fifty parts by mass of this concentrated liquid containing the fine pigment particles, 7.5 parts by mass of diethylene glycol, 5 parts by mass of glycerol, 5 parts by mass of trimethylolpropane, 0.2 part by mass of Acetylenol EH and 32.3 parts by mass of ion-exchanged water were mixed to prepare an ink composition.

<Evaluation as to Printing>

The ink composition prepared was charged into an ink jet printer BJF 800 (trade name, manufactured by Canon Inc.) to conduct ink jet recording of a solid-printed image on plain paper. The resultant recorded article was visually evaluated. As a result, it was confirmed that the article had a bright hue.

The ink composition prepared was also charged into the ink jet printer BJF 800 (trade name, manufactured by Canon Inc.) to conduct ink jet recording of a character image on plain paper, thereby evaluating the ink composition as to ejection stability.

The ejection stability was evaluated by continuously printing 1,000,000 English characters and numerals and visually observing the resultant prints. As a result, beautiful printing could be conducted without causing problems of blurring or ejection failure to the end.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-161523, filed Jun. 9, 2006, which is hereby incorporated by reference herein in its entirety.

What is claimed is:

1. A process for producing pigment particles with a polymer chain formed on the surfaces of the particles through grafting, the process comprising (1) causing a dispersant composed of a polymer compound having a polymerization initiation group to be contained in either one solvent of a first solvent and a second solvent, (2) obtaining a solution dissolving a pigment in the first solvent, (3) mixing the solution with the second solvent to precipitate pigment particles having the polymerization initiation group on the surfaces thereof, and (4) forming a polymer chain through grafting from the polymerization initiation group on the surfaces of the pigment particles.

2. The production process according to claim 1, wherein the first solvent is an aprotic solvent.

3. The production process according to claim 1, wherein the first solvent is a mixed solvent of an aprotic solvent and an alkali.

4. The production process according to claim 1, wherein the second solvent is one of water and an aqueous solution.

5. The production process according to claim 1, wherein the polymer chain is a polymer chain having a dispersing function in water or an aqueous solution.

6. The production process according to claim 1, wherein the polymerization initiation group is a living polymerization initiation group.

7. A liquid composition containing the pigment particles produced by the process according to claim 1.

8. An ink jet recording ink composition comprising the liquid composition according to claim 7.

9. An image forming process comprising applying the ink composition according to claim 8 to a medium, thereby recording an image.

10. An image forming apparatus comprising a unit for applying the ink composition according to claim 8 to a medium, thereby recording an image.
